(19) United States
(12) Patent Application Publication
(10) Pub. No.: US 2016/0034956 A1
(43) Pub. Date: Feb. 4, 2016

(54) PRESENTING TARGETING CRITERIA OPTIONS FOR INCLUSION IN TARGETING CRITERIA ASSOCIATED WITH CONTENT ITEMS

(71) Applicant: Facebook, Inc., Menlo Park, CA (US)

(72) Inventors: Giridhar Rajaram, Cupertino, CA (US); Weiwei Ding, Fremont, CA (US); Xingyao Ye, Mountain View, CA (US); Leon Cho, Menlo Park, CA (US)

(21) Appl. No.: 14/446,176

(22) Filed: Jul. 29, 2014

(51) Int. Cl. G06Q 30/02

(52) U.S. Cl. CPC G06Q 30/0256; G06Q 50/01

(57) ABSTRACT

An online system allows content items to be targeted based on interests associated with users. When the online system receives a request to specify targeting criteria associated with a content item, the online system provides an interface to specify targeting criteria. As the online system receives input specifying an interest for inclusion in targeting criteria, the online system retrieves stored interests associated with online system users. Each interest stored by the online system is associated with a type. For example, a type associated with a stored interest indicates whether the interest is from a set of user-generated keywords, from a set of semantic topics mapped from the keywords, or from a set of manually curated broad categories. To avoid confusion from overlap in the types of interests, the online system applies rules to stored interests matching at least a portion of the input to select a set of interests.

### BACKGROUND

This disclosure relates generally to identifying content for presentation to users of an online system, and more specifically to selecting targeting criteria associated with content presented by an online system.

An online system, such as a social networking system, allows its users to connect to and communicate with other social networking system users. Users may create profiles on an online system that are tied to their identities and include information about the users, such as interests and demographic information. The users may be individuals or entities such as corporations or charities. Because of the increasing popularity of online systems and the increasing amount of user-specific information maintained by online systems, such as social networking systems, an online system provides an ideal forum for increasing engagement with various subjects by presenting content items about the subjects to online system users.

However, different users of an online system frequently have different interests, so content items highly interesting to a user may be uninteresting to another user. Presenting a user with uninteresting content items has minimal ability to increase the user's engagement with a subject associated with the content items. Accordingly, targeting criteria may be associated with a content item identifying characteristics of users likely to engage with a subject associated with the content item. The online system limits presentation of the content item to users having characteristics satisfying the targeting criteria associated with the content item.

An online system may maintain a significant amount of information about a user. While this enables specification of a wide range of targeting criteria based on different user information, selecting targeting criteria from the potential targeting criteria may be a time-intensive process. Although the online system may present suggestions for targeting criteria, the number of suggested targeting criteria may be too large for efficient selection of targeting criteria from the suggestions.

### SUMMARY

An online system, such as a social networking system, allows content items to be targeted based on interests associated with users. The online system maintains information identifying multiple interests each associated with one or more users of the online system. For example, interests maintained by the social networking system may be determined at least in part on interactions by online system users with objects maintained by the online system or interactions by online system with applications. Each interest stored by the online system is associated with a type. For example, a type associated with a stored interest indicates whether the interest is from a set of user-generated keywords, from a set of semantic topics mapped from the keywords, or from a set of manually curated broad categories. Additionally, the online system maintains associations between interests, which may be based at least in part on the types associated with interests. For example, an interest having a type indicating the interest is a keyword is associated with one or more interests having a type indicating the one or more interests are semantic topics, while an interest having a type indicating it is a semantic topic is associated with one or more interests having a type indicating the one or more interests are categories. Hence, the types associated with interests and associations between interests allow the online system to maintain a hierarchy of interests.

When the online system receives a request to specify targeting criteria associated with a content item, the online system provides an interface that allows the user to provide the desired targeting criteria. As the online system receives input specifying an interest for inclusion in targeting criteria, the online system retrieves maintained interests associated with online system users. For example, the online system retrieves maintained interests at least partially matching a portion of the received input. To avoid confusion (e.g., from overlap in the types of interests), the online system applies rules to the maintained interests matching at least a portion of the input to select a set of interests. The rules may be based at least on types associated with interests. For example, one or more rules exclude interests having a specified type, such as a type specifying the interest as a category, from inclusion in the set of interests. As another example, a rule identifies interests that are synonyms with each other and a type of an interest identified as a synonym for inclusion in the set. If an interest from the set of interests is selected for inclusion in targeting criteria associated with the content item, a user is determined to satisfy the targeting criteria if characteristics of the user match or satisfy the selected interest or one or more additional interests associated with the selected interest.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is an example illustrating associations between interests maintained by an online system, in accordance with an embodiment.

FIG. 4 is a flowchart of a method for specifying interests stored by an online system as targeting criteria for a content item, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

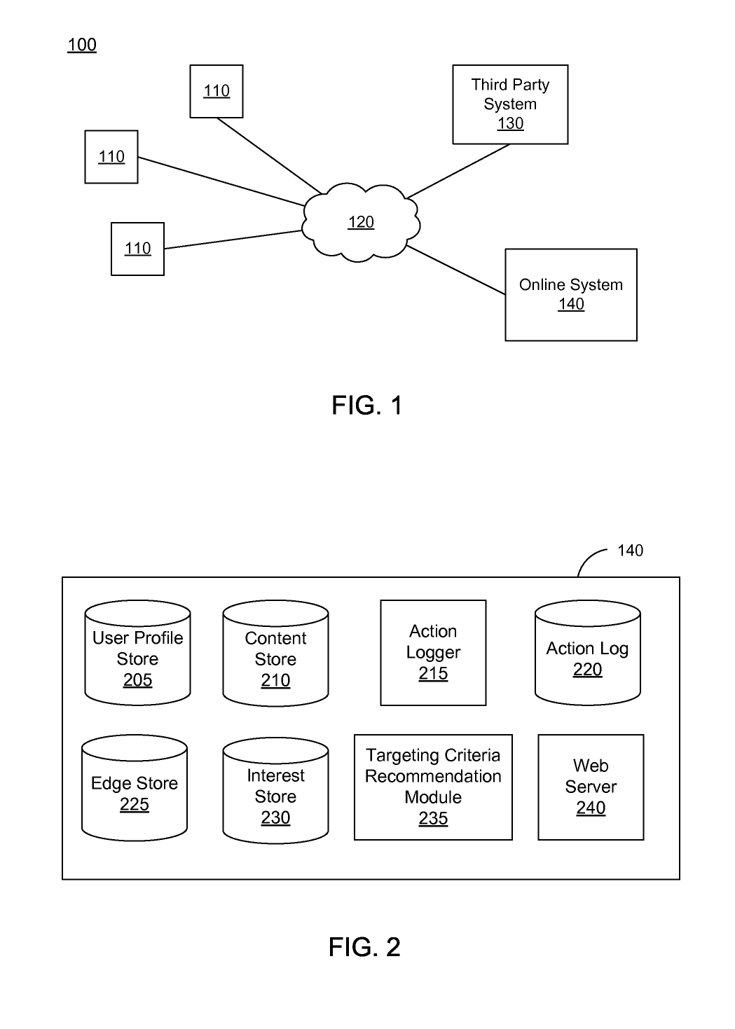

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

FIG. 2 is a block diagram of an architecture of the online system 140. For example, the online system 140 is a social networking system. The online system 140 shown in FIG. 2 includes a user profile store 205, a content store 210, an action logger 215, an action log 220, an edge store 225, an advertisement (“ad”) store 230, an interest store 235, and a targeting criteria recommendation module 240, and a web server 245. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system using a brand page associated with the entity's user profile. Other users of the online system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, an advertisement (ad), or any other type of content. Other examples of content include content items created in an environment or in a system external to the online system 140, including content items generated by an online system user. Online system users may create objects stored by the content store 210, such as status updates, photos tagged by users to be associated with other objects in the online system, events, groups or applications. In some embodiments, objects, such as ads, are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or another user in the online system 140 based on the actions performed by the user. A user's affinity may be computed by the online system 140 over time to approximate a user's interest for an object, a topic, or another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement requests (“ad requests”) are included in the ad request store 230. An advertisement request includes advertisement content and a bid amount. The advertisement content is text, image, audio, video, or any other suitable data presented to a user. In various embodiments, the advertisement content also includes a landing page specifying a network address to which a user is directed when the advertisement is accessed. The bid amount is associated with an advertisement by an advertiser and is used to determine an expected value, such as monetary compensation, provided by an advertiser to the online system 140 if the advertisement is presented to a user, if the advertisement receives a user interaction, or based on any other suitable condition. For example, the bid amount specifies a monetary amount that the online system 140 receives from the advertiser if the advertisement is displayed and the expected value is determined by multiplying the bid amount by a probability of the advertisement being accessed.

Additionally, an advertisement request may include one or more targeting criteria specified by the advertiser. Targeting criteria included in an advertisement request specify one or more characteristics of users eligible to be presented with advertisement content in the advertisement request. For example, targeting criteria are used to identify users having user profile information, edges or actions satisfying at least one of the targeting criteria. As another example, targeting criteria may identify one or more interests of a user, which are further described below. Hence, targeting criteria allow an advertiser to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sending a message to another user, using an application, joining a group, leaving a group, joining an event, generating an event description, purchasing or reviewing a product or service using an online marketplace, requesting information from a third-party system 130, or any other suitable action. Including actions in targeting criteria allows advertisers to further refine users eligible to be presented with content from an advertisement request. As another example, targeting criteria identifies users having a connection to another user or object or having a particular type of connection to another user or object. While the ad request store 230 includes targeting criteria associated with advertisement content, targeting criteria may be associated with any type of content item to identify users eligible to be presented with a content item.

The interest store 235 includes information identifying interests associated with various users of the online system 140 and associations between various interests. Each interest is associated with a type describing a level of detail or source of the interest. Interests are determined from interactions performed by a user and captured by the online system 140. In one embodiment, the online system 140 determines one or more interests based on characteristics of objects maintained by the online system 140 with which users interact or based on applications that the user uses. For example, the online system 140 determines an interest as one or more keywords extracted from a title, a subject, or other content included in an object (e.g., a page) with which the user performs one or more types of interactions (e.g., indicates a preference for an object, shares an object, etc.). As another example, the online system 140 determines an interest as one or more keywords extracted from a title, a genre, a third-party system 130 or other information associated with an application with which the user interacts. The interest store 235 associates a type with an interest extracted from content included in an object or associated with an application as a keyword extracted from an object with which a user interacts.

Additionally, the online system 140 maps interests extracted from content included in an object or associated with an application to one or more semantic topics. For example, the interest store 235 includes various rules mapping keywords extracted from content to one or more semantic topics and the online system 140 applies one or more of the rules to a keyword extracted from content to map the keyword to one or more semantic topics. In various embodiments, the semantic topics correspond to more general interests than the keywords, allowing the interest store 235 to associate more specific interests extracted from content included in an object or associated with an application to broader interests identified by the semantic topics. The interest store 235 associates a type with an interest determined through mapping a keyword to a semantic topic indicating that the interest is a semantic topic. Hence, the interest store 235 may maintain a hierarchy associating interests extracted from content with broader interests identified by mapping the interests extracted from content to one or more semantic topics.

In some embodiments, a semantic topic is associated with one or more categories, which are broader than the semantic topics. For example, one or more users of the online system 140 manually associate a semantic topic with one or more categories. Alternatively, the interest store 235 includes rules for associating a semantic topic with one or more categories, and the online system 140 applies one or more of the rules to a semantic topic to identify one or more categories associated with the semantic topic. An interest determined by associating a semantic topic with a category is associated with a type indicating the interest is a category.

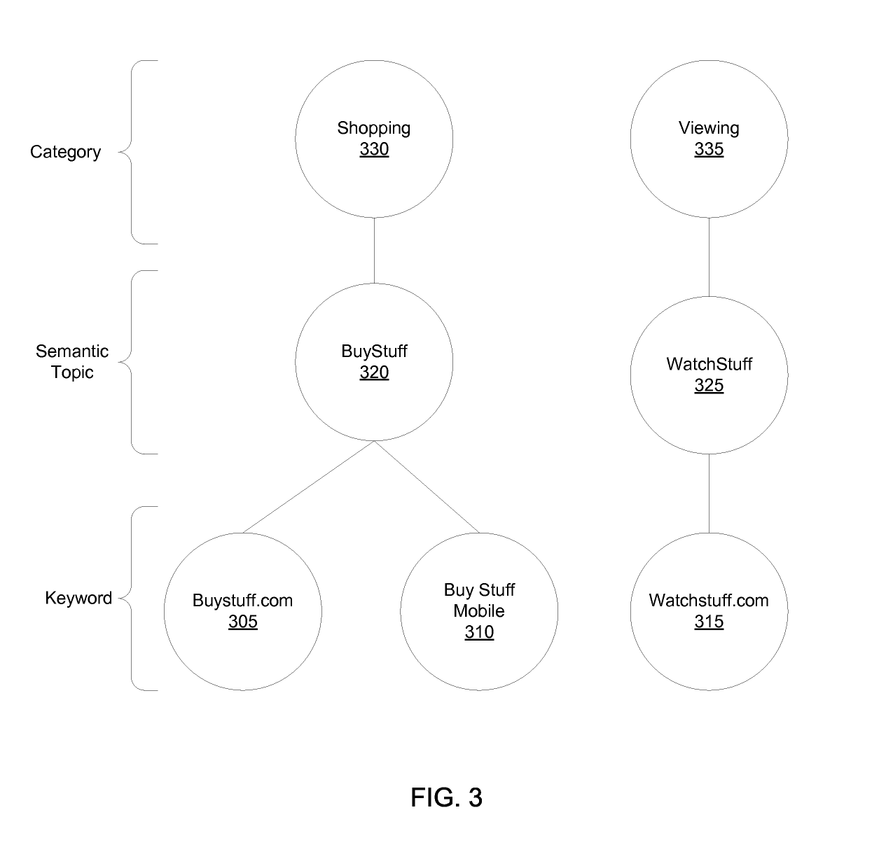

Maintaining various types of interests allows the interest store 235 to maintain a hierarchy of interests specifying relationships between various interests. FIG. 3 shows example associations between interests included in the interest store 235. In the example of FIG. 3 interests are associated with a type indicating an interest as a keyword extracted from content associated with an application or included in an object, a type indicating an interest as a semantic topic mapped to one or more keywords, or a type indicating an interest as a category.

As shown in FIG. 3, interests 305 and 315 are keywords extracted from content include in objects with which a user interacts. In the example of FIG. 3, interests 305 and 315 are network addresses included in objects with which the user interacted. For example, interest 305 is a domain name included in an object for which the user expressed a preference through the online system 120 and interests 315 is a domain name included in an object that the user shared with another user of the online system. Interest 310 in FIG. 3 is a keyword extracted from content associated with an application the user executes on a client device 110. In the example of FIG. 3, interest 310 is an application name. However, in other embodiments, the online system 140 extracts multiple keywords from content included in an object with which the user interacts or from content associated with an application the user executes, and any suitable information may be extracted from content and stored as an interest.

Interests 320 and 325 in FIG. 3 are semantic topics determined by applying one or more rules to interests 305, 310, and 315. In one embodiment, information stored by the online system 140 associates various keywords with different semantic topics, so the online system 140 maps a keyword to a semantic topic identified by the stored information. For example, the online system 120 includes information associating one or more domain names and one or more application names with a company name, so a keyword that is one of the domain names is mapped to the company name. In the example of FIG. 3, interest 305 and interest are associated with interest 320 based on information maintained by the online system 140, while interest 315 is associated with interest 325 based on the information maintained by the online system 140.

Additionally, in FIG. 3, one or more semantic topics are mapped to a category. Input or instructions provided to the online system 140 by one or more users may associate semantic topics with a category in some embodiments. Alternatively, information or rules stored by the online system associate semantic topics with one or more categories. For example, semantic topics that are company names are associated with one or more categories describing genres associated with the companies. In the example of FIG. 3, interest 320 is associated with interest 330 and interest 325 is associated with interest 335 based on information or inputs associating the semantic topics of interest 330 and interest 325 with one or more categories.

Associations between different types of interests allow the online system 140 to maintain a hierarchy of interests based on the types. For example, interests that are keywords identify a specific interest, while interests that are categories identify a broad interest. In some embodiments, the online system 140 uses associations between interests when determining whether a user satisfies one or more targeting criteria. For example, if the online system 140 determines the user has characteristics satisfying an interest, the online system 140 also determines the user has characteristics satisfying additional interests that are associated with the interest satisfied by the user characteristics.

Referring to FIG. 2, the online system 140 includes a targeting criteria recommendation module 240, which presents one or more interests selected from the interest store 235 to a user requesting creation of targeting criteria to associate with a content item. For example, the online system 140 receives a request from a user to associate targeting criteria with a content item and communicates an interface for specifying targeting criteria to a client device 110 for presentation to the user. When the online system 140 receives input via the interface, the targeting criteria recommendation module 240 identifies candidate interests from the interest store 235 where at least a portion of a candidate interest matches a portion of the received input.

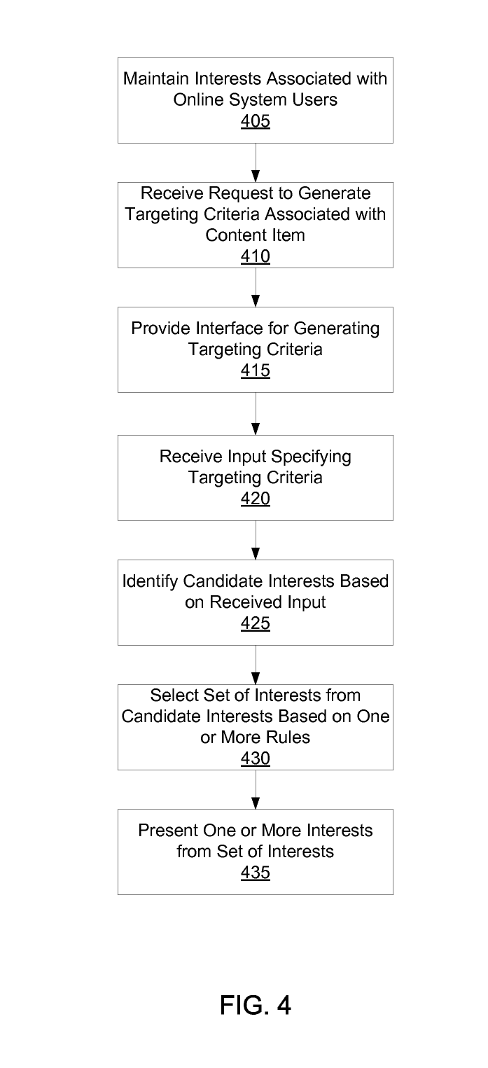

To simplify selection of targeting criteria from the candidate interests, the targeting criteria recommendation module 240 includes one or more rules that are applied to the candidate interests to select a set of interests from the candidate interests. Application of the rules reduces the number of candidate interests presented via the interface, allowing the user to more easily identify a targeting criteria from the interests stored in the interest store 235. One or more of the rules removes candidate interests from the set based at least in part on types associated with various candidate interests. For example, one or more rules identify interests having a types indicating they are extracted from content that match a normalized form of an interest having a type indicating it is a semantic topic criteria for selecting an interest for presentation from the identified interests; in one embodiment, a candidate interest associated with a semantic topic type that matches normalized forms of interests having a type indicating they were extracted form content is selected from the candidate interests for inclusion in the set. Application of rules to candidate interests to identify a set of interests for presentation to a user is further described below in conjunction with FIG. 4.

The web server 245 links the online system 140 via the network 120 to the one or more client devices 110, as well as to the one or more third party systems 130. The web server 245 serves web pages, as well as other content, such as JAVA®, FLASH®, XML and so forth. The web server 245 may receive and route messages between the online system 140 and the client device 110, for example, instant messages, queued messages (e.g., email), text messages, short message service (SMS) messages, or messages sent using any other suitable messaging technique. A user may send a request to the web server 245 to upload information (e.g., images or videos) that are stored in the content store 210. Additionally, the web server 245 may provide application programming interface (API) functionality to send data directly to native client device operating systems, such as IOS®, ANDROID™, WEBOS® or BlackberryOS.

### Identifying Interests for Selection as Targeting Criteria

FIG. 4 shows one embodiment of a method for identifying interests stored by an online system 140 as targeting criteria for a content item. In various embodiments, the steps described in conjunction with FIG. 4 may be performed in different orders than the order shown by FIG. 4. Additionally, in some embodiments, the method described in conjunction with FIG. 4 includes different and/or additional steps than those described in conjunction with FIG. 4.

The online system 140 maintains 405 interests associated with one or more users of the online system 140, with each interest associated with a type. Additionally, the online system 140 maintains 405 information describing associations interests based at least in part on the types associated with various interests. For example, the online system 140 maintains 405 interests determined as keywords extracted from content included in object or associated with an application with which a user interacts. An interest identified as a keyword extracted from content included in an object or associated with an application is associated with one or more interests that are semantic topics. For example, the online system 140 maps an interest extracted from content included in an object of associated with an application to one or more semantic topics based on one or more rules and maintains 405 associations between the interest extracted from content included in an object of associated with an application and the one or more semantic topics. In some embodiments, the online system 140 also maintains 405 mapping a semantic topic to one or more categories. An interest identified as a semantic topic may be broader than an interest identified as a keyword, while an interest identified as a category may be broader than an interest identified as a semantic topic. Hence, the maintained information describing interests allows the online system 140 to specify a hierarchy of various interests with different levels in the hierarchy having different breadths.

While the interests and associations between interests are maintained 405, the online system 140 receives 410 a request to generate targeting criteria associated with a content item. The request may identify a content item stored by the online system 140 or may include the content item for association with the targeting criteria. The targeting criteria identify one or more characteristics of online system users eligible to be presented with the content item associated with the targeting criteria. For example, the online system receives 410 a request to generate an ad request including a request to generate targeting criteria for the ad request. The targeting criteria may specify one or more interests associated with online system users to limit presentation of a content item associated with the targeting criteria to users associated with at least a threshold number of the interests specified by the targeting criteria.

After receiving 410 the request to generate targeting criteria, the online system 140 provides 415 the user with an interface for specifying the targeting criteria. In one embodiment, the online system 140 communicates instructions for generating the interface to a client device 110 associated with the user, and the client device 110 executes the instructions to present the interface to the user. The interface may present multiple fields, with each field associated with one or more targeting criteria.

When the online system 140 receives 420 an input for specifying the targeting criteria from the user, the online system 140 identifies 425 one or more candidate interests from the interest store 235. At least a portion of a candidate interest matches at least a portion of the received input. For example, when the online system 140 receives 420 a group of characters specifying the targeting criteria, the online system 140 identifies 425 one or more interests from the interest store 235 including a group of characters matching the received group of characters. In one embodiment, the online system 140 compares groups of characters in one or more specific locations of a stored interest (e.g., a beginning or an end of the stored interest) to received characters, and identifies 425 interests including the group of characters in at least one of the specific locations matching the received characters as candidate interests.

Because the online system 140 may frequently maintain 405 information describing a large number of interests, a number of candidate interests too large to be easily presented to the user may be identified 425. For example, interests identified as keywords extracted from content included in an object, as well as interests identified as semantic topics associated with multiple interests identified as keywords extracted from content may be identified 425 as candidate interests. If the interests are maintained 410 in a hierarchy, the interests identified as semantic topics may encompass interests identifies as keywords extracted from content items, so presenting both the interests identified as keywords and the interests identified as semantic topics would be redundant and provide the user with an amount of information from which the user may be unable to easily identify targeting criteria.

To simplify selection of targeting criteria by the user, the online system 140 selects 430 a set of interests from the candidate interests by applying one or more rules to the candidate interests. Each of the one or more rules specify criteria for excluding one or more candidate interests from the set of candidate interests based at least in part on a type associated with a candidate interest. For example, one or more rules identify interests having a types indicating they are extracted from content that match a normalized form of an interest having a type indicating it is a semantic topic criteria for selecting an interest for presentation from the identified interests; in one embodiment, a candidate interest associated with a semantic topic type that matches normalized forms of interests having a type indicating they were extracted form content is selected 430 from the candidate interests for inclusion in the set. As another example, one or more rules exclude candidate interests having a type indicating the candidate interests are categories from inclusion in the set of interests. In an additional example, one or more rules exclude a candidate interest determined to be identical to another candidate interest from the set of interests, so the set of interests does not include duplicate candidate interests. As a further example, based on information maintained by the online system 140, interests having a type indicating they are extracted from content that are synonyms one or more interests having a type indicating they are semantic topics are identified and one or more criteria are applied to the interests having the type indicating they are extracted from content to determine if the interests having the type indicating they are extracted from content are included in the set. In one embodiment, an interest having a type indicating it was extracted from content is included in the set if it is a synonym of an interest having a type indicating it is a semantic topic and the interest having at type indicating it was extracted from content is associated with an application associated with a threshold number of users and is not a substring of the interest having the type indicating it is a semantic topic; further, an interest having a type indicating it was extracted from content is included in the set if it is a synonym of an interest having a type indicating it is a semantic topic and the interest having at type indicating it was extracted from content is associated with at least a threshold number of users and has less than a threshold measure of similarity (e.g., edit distance between the interests) with the interest having the type indicating it is a semantic topic. While the online system 140 compares the portion of the received input to candidate interests having various types, applying the one or more rules to the candidate interests allows the online system to reduce the number of candidate interests presented to the user for selection as targeting criteria.

In some embodiments, when selecting 430 the set of candidate interests, the online system 140 accounts for potential revenue to the online system 140 from using various candidate interests as targeting criteria. For example, the online system 140 receives revenue from an entity associated with the content item when the online system 140 presents the content item to users or when online system users interact with the presented content item. To increase potential revenue to the online system 140 from presenting the content item, the online system 140 includes candidate interests in the set that maximize the revenue to the online system 140 if specified as targeting criteria or that would provide a threshold amount of revenue to the online system 140 if specified as targeting criteria. For example, after identifying 425 one or more candidate interests, the online system 140 determines a number of users having characteristics satisfying each candidate content item and determines an expected revenue to the online system 140 for each candidate interest. An expected revenue to the online system 140 from a candidate interest is based on an amount specified by an entity associated with the content item and the number of users having characteristics satisfying the candidate interest; in some embodiments, a likelihood of various users interacting with the content item is also used to determine the expected revenue to the online system for the candidate interest. The online system 140 may select 430 the set of candidate interests as candidate interests having at least a threshold amount of expected revenue to the online system 140 or having maximum expected revenues to the online system 140. Alternatively, the online system 140 may order the set of candidate interests based at least in part on the expected revenues to the online system 140 for each candidate interest in the set of candidate interests.

Interests from the selected set of interests are presented 435 to the user via the interface, allowing the user to select one or more of the presented interests as targeting criteria associated with the content item. In one embodiment, the online system 140 communicates one or more interests from the selected set of interests to a client device 110 associated with the user, which presents the one or more interests via the interface. For example, the one or more interests from the selected set of interests are presented proximate to the received input in the interface. When the user selects one or more of the interests presented 435 via the interface, the online system 140 receives information identifying the selected interests and associates the selected interests as well as one or more additional interests associated with at least one of the selected interests with the content item. The online system 140 associates the selected interests and one or more additional interests associated with at least one or the selected interests with the content item.

Subsequently, when the online system 140 receives a request to present content to a viewing user of the online system 140, the targeting criteria associated with the content item are retrieved. The online system 140 compares the targeting criteria associated with the content item to characteristics associated with the viewing user. When comparing the targeting criteria to the viewing user's characteristics, the online system 140 retrieves the one or more interests specified by targeting criteria associated with the content item as well as additional interests having an association maintained by the online system 140 with at least one interest specified by the targeting criteria. For example, if the targeting criteria specify an interest identified as a keyword extracted from content included in an object, the online system 140 retrieves one or more interests identified as semantic topics and associated with the interest specified by the targeting criteria. If the viewing user has characteristics matching, or otherwise satisfying, the interest specified in the targeting criteria or matching or satisfying at least a threshold number of the additional interests associated with the interest specified in the targeting criteria, the viewing user is identified as eligible to be presented with the content item associated with the targeting criteria specifying the interest.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
maintaining a plurality of interests associated with one or more users of an online system, each interest associated with a type, and information describing associations between interests based at least in part on the types associated with interests;
receiving a request from a user to generate targeting criteria associated with a content item, the targeting criteria identifying one or more characteristics of users eligible to be presented with the content item;
receiving an input identifying an interest for inclusion in the targeting criteria;
identifying one or more candidate interests from the maintained plurality of interests, at least a portion of each candidate interest matching at least a portion of the received input;
selecting a set of interests from the one or more candidate interests by applying one or more rules to the candidate interests, the one or more rules specifying criteria for excluding one or more candidate interests from the set of interests based at least in part on one or more types associated with the one or more candidate interests; and
presenting one or more interests of the selected set of interests to the user for specifying the targeting criteria.

2. The method of claim 1, wherein the type associated with an interest is selected from a group consisting of: a keyword generated from content included in an object with which one or more users interacted, a semantic topic mapped, and a category.

3. The method of claim 2, wherein the semantic topic is determined by mapping one or more keywords extracted from content included in the object with which one or more users interacted to a topic.

4. The method of claim 2, wherein the category is associated with one or more semantic topics based at least in part on manual input received by the online system.

5. The method of claim 1, further comprising:
receiving a selection of an interest from the set of interests;
identifying one or more additional interests associated with the selected interest from the set of interests; and
associating the selected interest and the identified one or more additional interests with the content item.

6. The method of claim 5, further comprising:
receiving a request for content from a viewing user of the online system;
retrieving characteristics associated with the viewing user that are maintained by the online system; and
identifying the viewing user as eligible to be presented with the content item if at least a threshold number of the characteristics associated with the viewing user satisfy the selected interest or the one or more additional interests.

7. The method of claim 1, wherein selecting the set of interests from the one or more candidate interests by applying one or more rules to the candidate interests comprises:
determining an expected revenue to the online system for each of the one or more candidate interests, an expected revenue to the online system for a candidate interest based at least in part on an amount of compensation provided to the online system by an entity associated with the content item and a number of users of the online system having characteristics satisfying the candidate interest; and
selecting the set of interests based at least in part on the determined expected revenues to the online system.

8. The method of claim 7, wherein selecting the set of interests based at least in part on the determined expected revenues comprises:
selecting candidate interests having at least a threshold expected revenue to the online system for inclusion in the set of interests.

9. The method of claim 7, wherein selecting the set of interests based at least in part on the determined expected revenues comprises:
selecting candidate interests having maximum expected revenues to the online system for inclusion in the set of interests.

10. The method of claim 1, wherein selecting the set of interests from the one or more candidate interests by applying one or more rules to the candidate interests comprises:
determining an expected revenue to the online system for each of the one or more candidate interests, an expected revenue to the online system for a candidate interest based at least in part on an amount of compensation provided to the online system by an entity associated with the content item and a number of users of the online system having characteristics satisfying the candidate interest; and
ordering interests in the set of interests based at least in part on the determined expected revenues to the online system.

11. The method of claim 1, wherein the content item comprises an advertisement request including advertisement content.

12. A computer program product comprising a computer-readable storage medium having instructions encoded thereon that, when executed by a processor, cause the processor to:
maintain a plurality of interests associated with one or more users of an online system, each interest associated with a type, and information describing associations between interests based at least in part on the types associated with interests;
receive a request from a user to generate targeting criteria associated with a content item, the targeting criteria identifying one or more characteristics of users eligible to be presented with the content item;
receive an input identifying an interest for inclusion in the targeting criteria;
identify one or more candidate interests from the maintained plurality of interests, at least a portion of each candidate interest matching at least a portion of the received input;
select a set of interests from the one or more candidate interests by applying one or more rules to the candidate interests, the one or more rules specifying criteria for excluding one or more candidate interests from the set of interests based at least in part on one or more types associated with the one or more candidate interests; and
present one or more interests of the selected set of interests to the user for specifying the targeting criteria.

13. The computer program product of claim 12, wherein the type associated with an interest is selected from a group consisting of: a keyword generated from content included in an object with which one or more users interacted, a semantic topic mapped, and a category.

14. The computer program product of claim 13, wherein the semantic topic is determined by mapping one or more keywords extracted from content included in the object with which one or more users interacted to a topic.

15. The computer program product of claim 13, wherein the category is associated with one or more semantic topics based at least in part on manual input received by the online system.

16. The computer program product of claim 12, wherein the computer readable storage medium further has instructions encoded thereon, that when executed by the processor, cause the processor to:
receive a selection of an interest from the set of interests;
identify one or more additional interests associated with the selected interest from the set of interests; and
associate the selected interest and the identified one or more additional interests with the content item.

17. The computer program product of claim 16, wherein the computer readable storage medium further has instructions encoded thereon, that when executed by the processor, cause the processor to:
receiving a request for content from a viewing user of the online system;
retrieving characteristics associated with the viewing user that are maintained by the online system; and
identifying the viewing user as eligible to be presented with the content item if at least a threshold number of the characteristics associated with the viewing user satisfy the selected interest or the one or more additional interests.

18. The computer program product of claim 12, wherein select the set of interests from the one or more candidate interests by applying one or more rules to the candidate interests comprises:
determine an expected revenue to the online system for each of the one or more candidate interests, an expected revenue to the online system for a candidate interest based at least in part on an amount of compensation provided to the online system by an entity associated with the content item and a number of users of the online system having characteristics satisfying the candidate interest; and
select the set of interests based at least in part on the determined expected revenues to the online system.

19. The computer program product of claim 18, wherein select the set of interests based at least in part on the determined expected revenues comprises:
select candidate interests having at least a threshold expected revenue to the online system for inclusion in the set of interests.

20. The computer program product of claim 12, wherein select the set of interests from the one or more candidate interests by applying one or more rules to the candidate interests comprises:
determine an expected revenue to the online system for each of the one or more candidate interests, an expected revenue to the online system for a candidate interest based at least in part on an amount of compensation provided to the online system by an entity associated with the content item and a number of users of the online system having characteristics satisfying the candidate interest; and
order interests in the set of interests based at least in part on the determined expected revenues to the online system.
